(19) United States
(12) Patent Application Publication
(10) Pub. No.: US 2010/0063816 A1
(43) Pub. Date: Mar. 11, 2010

(54) Method and System for Parsing of a Speech Signal

(76) Inventors: Ronen Faifkov, Rehovot (IL); Rabin Cohen-Tov, Rehovot (IL)

Correspondence Address: The Law Office of Michael E. Kondoudis, 888 16th Street, N.W., Suite 800, Washington, DC, 20006, US

(21) Appl. No.: 12/205,881

(22) Filed: Sep. 7, 2008

(51) Int. Cl. G10L 15/00

(52) U.S. Cl. 704/236; 704/E15.001

(57) ABSTRACT

A method for processing an analog speech signal for speech recognition. The analog speech signal is sampled to produced a sampled speech signal. The sampled speech signal is framed into multiple frames of the sampled speech signal. The absolute value of the sampled speech signal is integrated within the frames and respective integrated-absolute values of the frames are determined. Based on the integrated-absolute values, the sampled speech signal is cut into segments of non-uniform duration. The segments are not as yet identified as parts of speech prior to and during the cutting.

### FIELD AND BACKGROUND

The present invention relates to speech recognition and, more particularly, to the conversion of an audio speech signal to readable text data. Specifically, the present invention includes a system and method which improves speech recognition performance by parsing the input speech signal into segments of non-uniform duration based on intrinsic properties of the speech signal.

In prior art speech recognition systems, a speech recognition engine typically incorporated into a digital signal processor (DSP), inputs a digitized speech signal, and processes the speech signal by comparing its output to a vocabulary found in a dictionary. In prior art systems, the input analog speech signal is sampled, digitized and cut into frames of equal time windows or time duration, e.g. 25 millisecond window with 10 millisecond overlap. The frames of the digital speech signal are typically filtered, e.g. with a Hamming filter, and then input into a circuit including a processor which performs a Fast Fourier transform (FFT) using one of the known FFT algorithms. After performing the FFT, the frequency domain data is generally filtered, e.g. Mel filtering to correspond to the way human speech is perceived. A sequence of coefficients are used to generate voice prints of words or phonemes based on Hidden Markov Models (HMMs). A hidden Markov model (HMM) is a statistical model where the system being modeled is assumed to be a Markov process with unknown parameters, and the challenge is to determine the hidden parameters, from the observable parameters. Based on this assumption, the extracted model parameters can then be used to perform speech recognition. The model gives a probability of an observed sequence of acoustic data given a word phoneme or word sequence and enables working out the most likely word sequence.

In human language, the term “phoneme” as used herein is the smallest unit of speech that distinguishes meaning or the basic unit of sound in a given language that distinguishes one word from another. An example of a phoneme would be the ‘t’ found in words like “tip”, “stand”, “writer”, and “cat”.

The term “frame” as used herein refers to portions of a speech signal of equal durations or time windows.

### BRIEF SUMMARY

According to an aspect of the present invention, there is provided a method of processing an analog speech signal for speech recognition. The analog speech signal is sampled to produced a sampled speech signal. The sampled speech signal is framed into multiple frames of the sampled speech signal. The frames are of typical duration between 7 and 9 milliseconds. The absolute value of the sampled speech signal is integrated within the frames and respective integrated-absolute values of the frames are determined. Based on the integrated-absolute values, the sampled speech signal is cut into segments of non-uniform duration. The segments are not as yet identified as parts of speech prior to and during the cutting. The sampling is typically performed at rate between 7 and 9 kilohertz. The integrated-absolute values are preferably used for finding peaks and valleys of the sampled speech signal. The cutting is preferably based on changes in slope of the integrated-absolute values in the valleys. The respective zero-crossing rates of the sampled speech signal during the frames are calculated based on the number of sign changes of the signal within each of the frames. The sampled speech signal is optionally cut based on the zero-crossing rates and/or the integrated-absolute values. Alternatively, the cutting is based only on changes in zero-crossing rates in the valleys, or based on both zero-crossing rates and the integrated-absolute values. The signals, i.e. integrated-absolute value and zero crossing rate are typically normalized so that all amplitudes of the signals have absolute values less than one. Median filtering is preferably performed on the sampled speech signal prior to calculating the zero crossing rates and and prior to determining the integrated-absolute values. For each of the segments, a standard deviation of the sampled speech signal is preferably calculated and high pass filtering of the sampled speech signal is performed to produce a high-pass-filtered signal component. One or more of the zero-crossing rate, the integrated-absolute value, the standard deviation and/or the high pass filtered signal, is used to cut the sampled speech signal within the segment into unidentified parts of speech of non-uniform duration. Rates of change are calculated for the calculated signals, and the cutting is performed within the segment based on the respective rates of change of the calculated signals within the segment. When multiple rates of change are calculated respectively for the calculated signals, the cutting is preferably performed within the segment based on the largest of the rates of change during the segment.

According to another aspect of the present invention there is provided a method of processing an analog speech signal for speech recognition. The analog speech signal, is sampled to produce a sampled speech signal. The sampled speech signal is framed to produce multiple frames of the sampled speech signal. Based on at least one intrinsic property within the frames of the sampled speech signal, the sampled speech signal is cut into segments of non-uniform duration, wherein prior to and during cutting, the segments are not as yet identified as parts of speech. The intrinsic property is preferably integrated absolute, zero crossing rate, standard deviation and/or a high-pass filtered component of the sampled speech signal.

According to a feature of the present invention, a computer readable medium is encoded with processing instructions for causing a processor to execute one or more of the methods disclosed herein.

The foregoing and/or other aspects will become apparent from the following detailed description when considered in conjunction with the accompanying drawing figures.

### BRIEF DESCRIPTION OF THE DRAWINGS

The invention is herein described, by way of example only, with reference to the accompanying drawings, wherein:

FIG. 1 is a graph illustrating a sampled speech signal and calculated signals based on the sampled speech signal used in accordance with some embodiments of the present invention;

FIGS. 2A and 2B illustrate a method, according to an embodiment of the present invention;

FIG. 3 shows a graph of a speech signal cut according to the method of FIG. 2A; and

FIG. 4 illustrates schematically a simplified computer system of the prior art.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

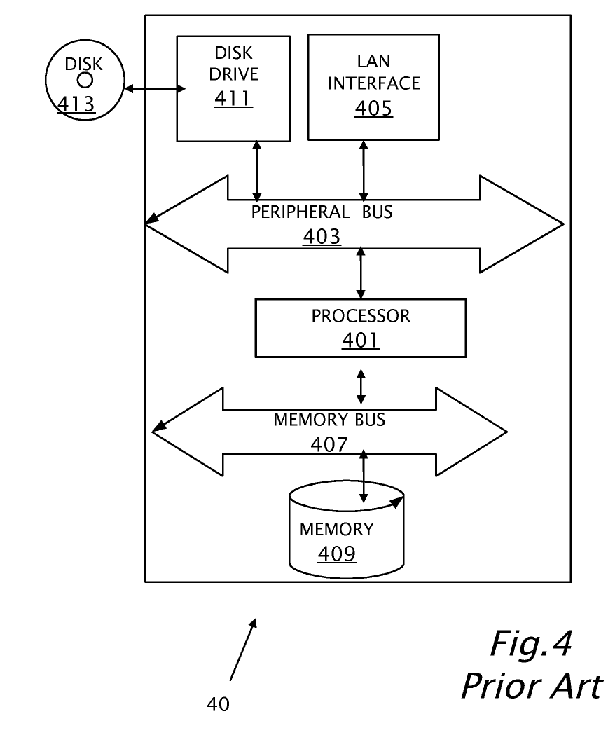

Reference is now made to FIG. 4 which illustrates schematically a simplified computer system 40. Computer system 40 includes a processor 401, a storage mechanism including a memory bus 407 to store information in memory 409 and a network interface 405 operatively connected to processor 401 with a peripheral bus 403. Computer system 40 further includes a data input mechanism 411, e.g. disk drive for a computer readable medium 413, e.g. optical disk. Data input mechanism 411 is operatively connected to processor 401 with peripheral bus 403.

By way of introduction, a principal intention according to embodiments the present invention is to improve the performance of a speech recognition engine by parsing the input speech signal into segments of varying time duration. Parsing of the input speech signal is dependent on intrinsic properties of the speech signal and not dependent on the recognition of the portions of the speech signal as parts of speech. Furthermore, the parsing of the speech signal, according to embodiments of the present invention, is independent of the rate of speech. For rapid speech and slow speech of the same spoken words, the parsing of the speech signal into segments of non-uniform duration is similar in terms of parts of speech. In contrast, in prior art methods which frame the spoken signal into frames of uniform duration, the same spoken words have a large variation of the number of frames included in two signals of the same words spoken at different rates.

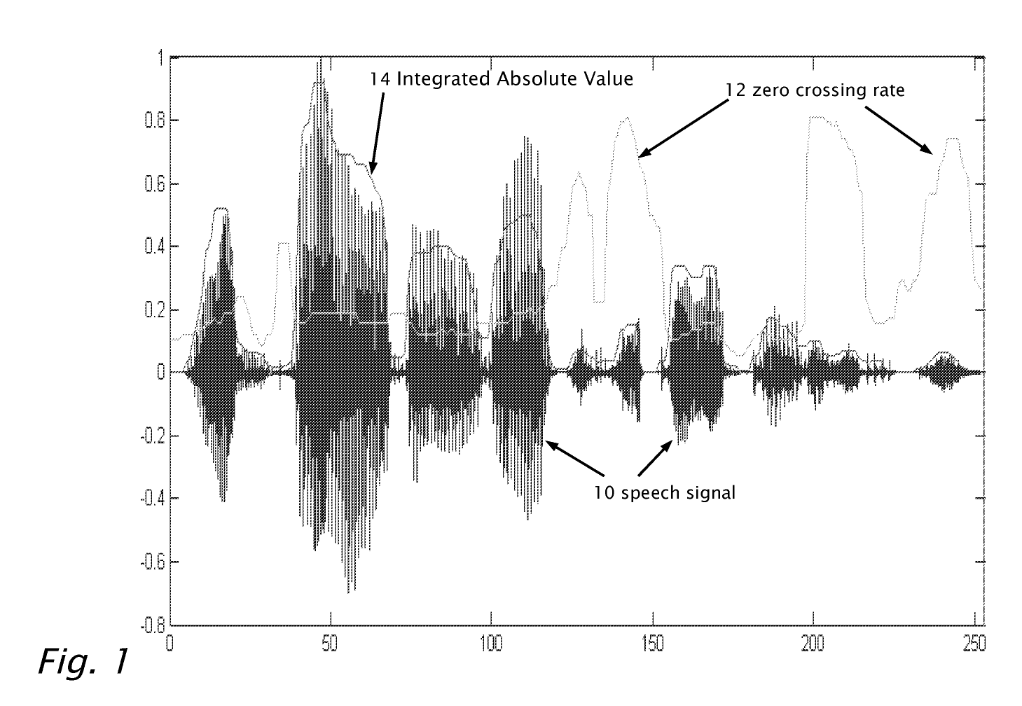

Referring now to the drawings, FIG. 1 shows a graph of a digitized and framed speech signal 10. The abscissa (x-axis) is the number of frames and the ordinate (y-axis) is signal intensity of speech signal 10 on a relative scale. Two other signals are also shown in the graph of FIG. 1, an integrated absolute value 14 of speech signal 10 as a function of frame number and zero crossing rate 12 as a function of frame number. Integrated absolute value 14 is typically the integral within the frame of the absolute value of the speech signal. Alternatively, integrated absolute value may be obtained by using either the positive or negative portions of speech signal 10 and integrated absolute value within each frame. Zero crossing rate 12 within the frame is typically equal or proportional to the number of zero crossings within the frame.

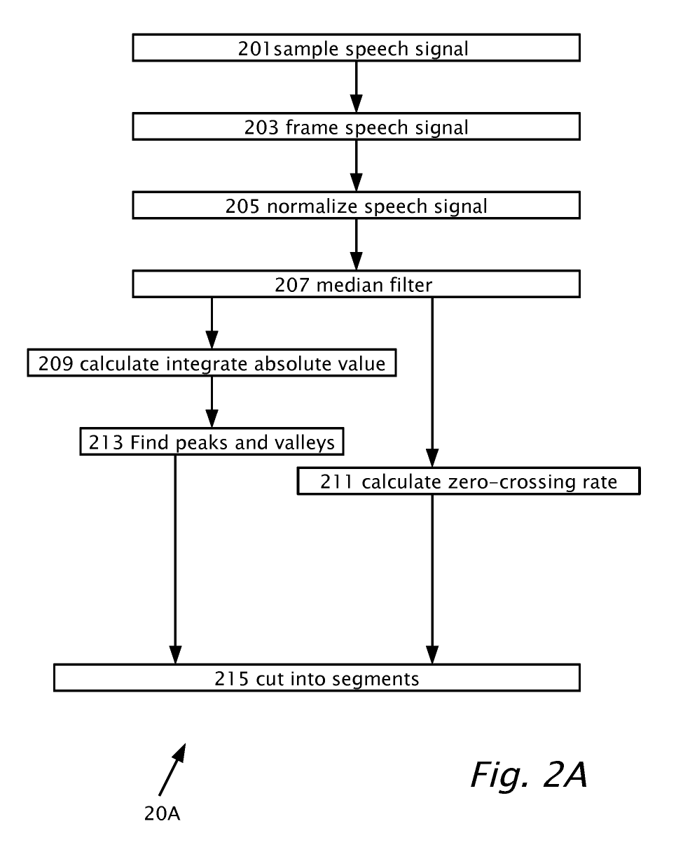

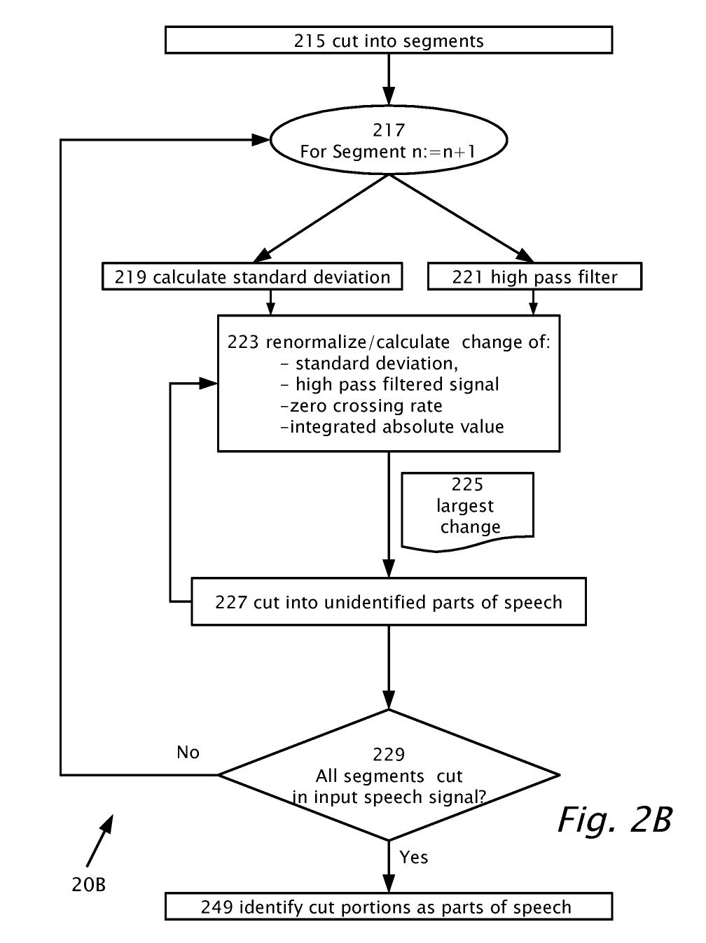

Reference is now made to FIGS. 2A and 2B which illustrate a method 20, according to an embodiment of the present invention. Referring to FIG. 2A, analog speech signal is digitized and sampled (step 201) to produce a sampled speech signal. The sampling is preferably performed at a sampling rate between 7 and 9 kilohertz, preferably at or near 8 kilohertz. The sampled speech signal is framed (step 203) into frames of equal duration (or window typically between 7-9 milliseconds or nominally 8 milliseconds) The sampled speech signal is preferably normalized (step 205) so that the signal peaks correspond to ±1. The frames are preferably median filtered (step 207) in order to reduce deleterious effects of noise. Intrinsic properties of sampled speech signal 10 are then calculated. The positive and/or negative portions of speech signal 10 are used to calculate (step 209) integrated absolute value 14 of speech signal 10. Zero crossing rate is calculated (step 211) of speech signal 10 which is equal or proportional to the number of zero crossings within each frame.

Peaks and valleys of speech signal 10 are located (step 213) preferably based on the calculated integrated absolute value. Segments of non-uniform duration are cut (step 215) from input speech signal based on changes in integrated absolute value 14 and/or zero crossing rate 12. The term “change” as used herein includes the differential, difference or ratio of signals, e.g. integrated absolute value 14 and/or zero crossing rate 12 between typically adjacent frames.

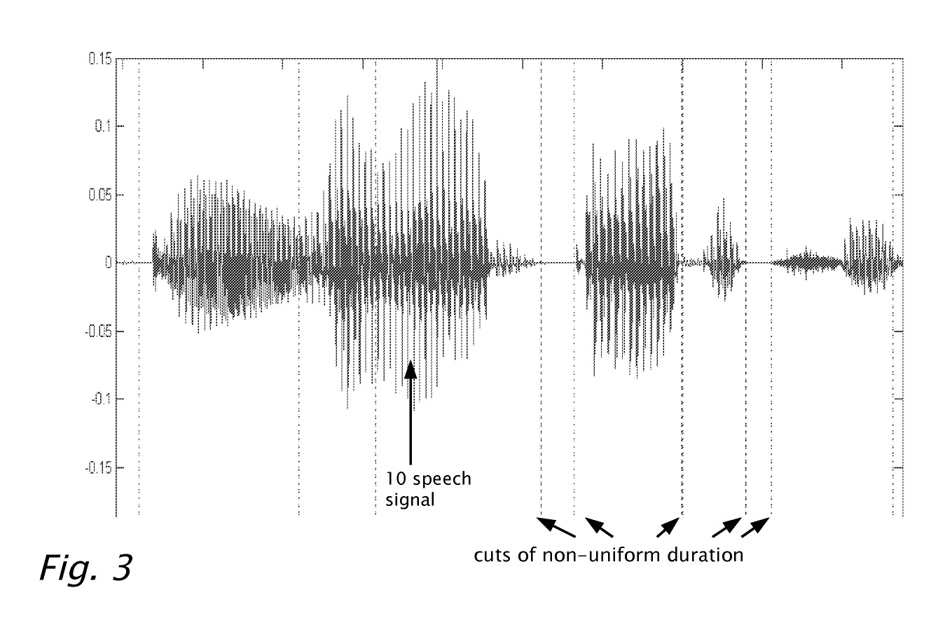

Reference is now made to FIG. 3, which illustrates speech signal 10 and segments cut (step 215) at the end of method 20A. Some of the cuts are indicated by the dashed lines, parallel to the ordinate (y-axis).

Referring now to FIG. 2B which includes a flow diagram 20B a continuation of method 20A of FIG. 2A. At the end of method 20A, speech signal 10 is cut into segments (step 215). The segments are processed individually (step 217). For each segment, speech signal 10 is processed further. In step 219 standard deviation (step 219) of speech signal 10 is calculated and in step 221 speech signal 10 is passed through a high pass filter to generate a high pass filtered speech signal. At this point of process 20B, four signals are available: standard deviation, high pass filtered speech signal, zero crossing rate 12, and integrated absolute value 14. The four signals are renormalized as required. Changes of one or more of these four signals are calculated. The largest change 225 of the four available signals is preferably used for further cutting (step 227) at the time frame during which the largest change 225 of the signal occurs within each segment. The calculation (step 223) of changes of the available signals and cutting (step 227) are typically performed recursively until one or more minimal thresholds are reached (decision block 229), e.g. minimal time duration of the cut segments or minimal magnitude of change 225 is found in step 223. Cutting (step 227) is into parts of signal 10, which are still not identified (step 249) as parts of speech and may correspond to a portion of or multiple conventional phonemes. The subsequent identification (step 249) of the parsed speech signal may be based on any of the methods known in the art of speech recognition.

While the invention has been described with respect to a limited number of embodiments, it will be appreciated that many variations, modifications and other applications of the invention may be made.

1. A method of processing an analog speech signal for speech recognition, the method comprising the steps of:
sampling the analog speech signal, thereby producing a sampled speech signal;
framing the sampled speech signal, thereby producing a plurality of frames of said sampled speech signal;
integrating absolute value of said sampled speech signal within said frames, thereby determining respective integrated-absolute values of said frames; and
based on said integrated-absolute values, cutting said sampled speech signal into segments of non-uniform duration, wherein prior to and during said cutting, said segments are not identified as parts of speech.

2. The method, according to claim 1, wherein sampling is performed at rate between 7 and 9 kilohertz.

3. The method, according to claim 1, wherein said frames are of duration between 7 and 9 milliseconds.

4. The method, according to claim 1, wherein said integrated-absolute values are used for finding peaks and valleys of said sampled speech signal

5. The method, according to claim 4, wherein said cutting is based on changes in slope of said integrated-absolute values in said valleys.

6. The method, according to claim 1, further comprising the step of:
calculating respective zero-crossing rates of said frames based on the number of sign changes during said frames and wherein said cutting is based on at least one calculated signal selected from the group of said zero-crossing rates and said integrated-absolute values.

7. The method, according to claim 6, wherein said cutting is based only on changes in zero-crossing rates in said valleys.

8. The method, according to claim 6, wherein said cutting is based on both zero-crossing rate and said integrated-absolute value.

9. The method, according to claim 6, further comprising the step of, prior to said calculating and said determining:
normalizing said at least one calculated signal so that all amplitudes of said at least one calculated signal have absolute values less than one.

10. The method, according to claim 8, further comprising the step of, prior to said calculating and said integrating:
median filtering said sampled speech signal within said frames.

11. The method of claim 1, further comprising the steps of:
for at least one of said segments second calculating a standard deviation of said sampled speech signal; and
for said at least one segment, high pass filtering said sampled speech signal and thereby producing a high-pass-filtered signal.

12. The method of claim 11, wherein based on at least one calculated signal selected from the group of said zero-crossing rate, said integrated-absolute value, said standard deviation and said high pass filtered signal, cutting said sampled speech signal within said at least one segment into unidentified parts of speech of non-uniform duration.

13. The method of claim 12, wherein a rate of change is calculated for said at least one calculated signal, and said cutting is performed within said at least one segment based on said rate of change during said at least one segment.

14. The method of claim 12, wherein said at least one calculated signal is a plurality of calculated signals, wherein a plurality of rates of change are calculated respectively for said calculated signals, and said cutting is performed within said at least one segment based on the largest of said rates of change during said at least one segment.

15. A computer readable medium encoded with processing instructions for causing a processor to execute the method of claim 1.

16. A method of processing an analog speech signal for speech recognition, the method comprising the steps of:
sampling the analog speech signal, thereby producing a sampled speech signal;
framing the sampled speech signal, thereby producing a plurality of frames of said sampled speech signal; and
based on at least one intrinsic property within said frames of said sampled speech signal, cutting said sampled speech signal into segments of non-uniform duration, wherein during said cutting said segments are not as yet identified as parts of speech.

17. The method of claim 16, wherein said at least one intrinsic property is selected from the group consisting of integrated absolute value, zero crossing rate, standard deviation and high-pass filtered component of said sampled speech signal.

18. A computer readable medium encoded with processing instructions for causing a processor to execute the method of claim 16.
